(19) United States
(12) Patent Application Publication
(10) Pub. No.: US 2005/0183079 A1
(43) Pub. Date: Aug. 18, 2005

(54) Tail duplicating during block layout

(76) Inventor: Jayashankar Bharadwaj, Saratoga, CA (US)

Correspondence Address: TROP PRUNER & HU, PC, 8554 KATY FREEWAY, SUITE 100, HOUSTON, TX, 77024, US

(21) Appl. No.: 10/771,080

(22) Filed: Feb. 3, 2004

(51) Int. Cl. G06F 9/45

(52) U.S. Cl. 717/159

(57) ABSTRACT

In one embodiment of the present invention, a method includes duplicating a block of a code segment into a tail duplicate block during block layout of the code segment, thus integrating block layout and tail duplication. After such duplication, the original block may be laid out and the tail duplicate block may be added to a candidate set of blocks.

### BACKGROUND

The present invention is directed to software for execution in a computer system, and more specifically to software development tools.

Software compilers compile or translate source code in a source language into target code in a target language. Compilers often perform additional functions, including optimization and scheduling of the target code.

Global scheduling is an important component of compilers and just-in-time (JIT) compilers designed for architectures supporting wide issue. The effectiveness of trace and hyperblock scheduling, which are global scheduling techniques for explicitly parallel instruction computing (EPIC), very large instruction word (VLIW), and superscalar architectures, depends on how well traces or hyperblocks are formed.

Scheduling involves movement of instructions within a control flow graph of program code. A control flow graph is an interconnected set of basic blocks, where each basic block is a series of instructions that always executes consecutively, under normal execution. Because every instruction in code is included in a basic block, the program may be entirely represented as a collection of basic blocks, interconnected by edges to reflect how program control flows between blocks.

A trace is a linear sequence of basic blocks in a chosen layout order. A hyperblock is a set of predicated basic blocks, in which control may only enter from the top, but may exit from one or more locations. Thus side entries are not allowed into hyperblocks and cause early hyperblock termination. A side entry can impose constraints on a trace scheduler.

As a result, global schedulers perform tail duplication to eliminate some or all side entries. However, tail duplication increases code size and can have negative effects on memory behavior for instruction cache and translation lookaside buffers. In managed run-time environments (MRTE's), which dynamically load and execute code delivered in a portable format, profile information is often available, making it desirable to selectively target tail duplication to eliminate cold side entries.

Compiler phases that perform basic block layout, tail duplication, and trace/hyperblock formation generally have certain ordering constraints. For example, basic block layout is typically done after all control flow graph changes (such as tail duplication) have been made, thus tail duplication must be done before basic block layout. Trace/hyperblock formation must be done after block layout has been completed. These phases are distinct steps, typically with tail duplication done first, then basic block layout, followed by trace or hyperblock formation. However, this phase ordering often results in excessive code expansion due to excessive tail duplication, and/or insufficient tail duplication resulting in smaller traces or hyperblocks. A need thus exists to perform effective tail duplication while reducing code bloat.

### BRIEF DESCRIPTION OF THE DRAWINGS

FIG. 1 is a flow diagram of a method in accordance with one embodiment of the present invention.

FIG. 2 is a flow diagram of a method in accordance with another embodiment of the present invention.

FIG. 3 is a region of code including a number of basic blocks.

FIG. 4A is a first trace formed in accordance with an embodiment of the present invention from the basic blocks shown in FIG. 3.

FIG. 4B is a second trace formed in accordance with an embodiment of the present invention from the basic blocks shown in FIG. 3.

FIG. 4C is a third trace formed in accordance with an embodiment of the present invention from the basic blocks shown in FIG. 3.

FIG. 5 is a block diagram of a system for use in accordance with an embodiment of the present invention.

### DETAILED DESCRIPTION

In various embodiments, the present invention includes a method to combine the phases of basic block layout, trace formation, and tail duplication into a single integrated phase. Block layout algorithms in accordance with an embodiment of the present invention may allow tail duplication of a block being laid out. In such manner, trace or hyperblock formation heuristics may guide tail duplication in concert with block layout. In certain embodiments, a layout algorithm may update its data structures to allow tail duplication of a given block that is being laid out immediately after one of its control flow predecessors. Then, the original of the given block may be laid out.

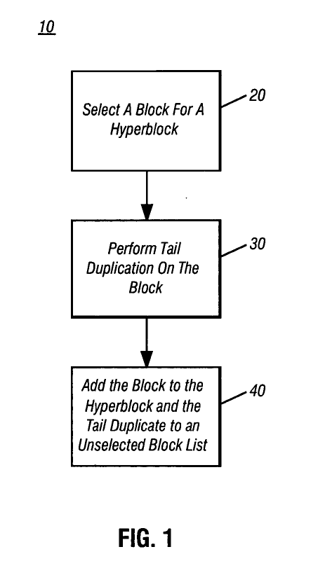

Referring now to FIG. 1, shown is a flow diagram of a method in accordance with one embodiment of the present invention. As shown in FIG. 1, method 10, which may be part of a block layout algorithm, may begin by selecting a block, such as a basic block, for inclusion in a hyperblock (block 20). Then, based on certain heuristics (and profile information, in certain embodiments), it may be determined that tail duplication should be performed on the block (block 30). For example, it may be determined that the block is a hot block that receives hot or cold side entries and would accordingly benefit from tail duplication.

Next, the block may be added to the hyperblock, and the tail duplicate may be added to various data structures of the layout algorithm, such as an unselected block list (block 40). In such manner, tail duplication may be performed in an integrated phase with basic block layout and trace/hyperblock formation. This allows trace/hyperblock formation heuristics to guide tail duplication in concert with the block layout process. In such manner, profile information may be more readily used to target tail duplication to selectively eliminate certain side entries. Furthermore, such profile information and feedback from trace/hyperblock formation may reduce excessive use of tail duplication, thereby reducing code bloat.

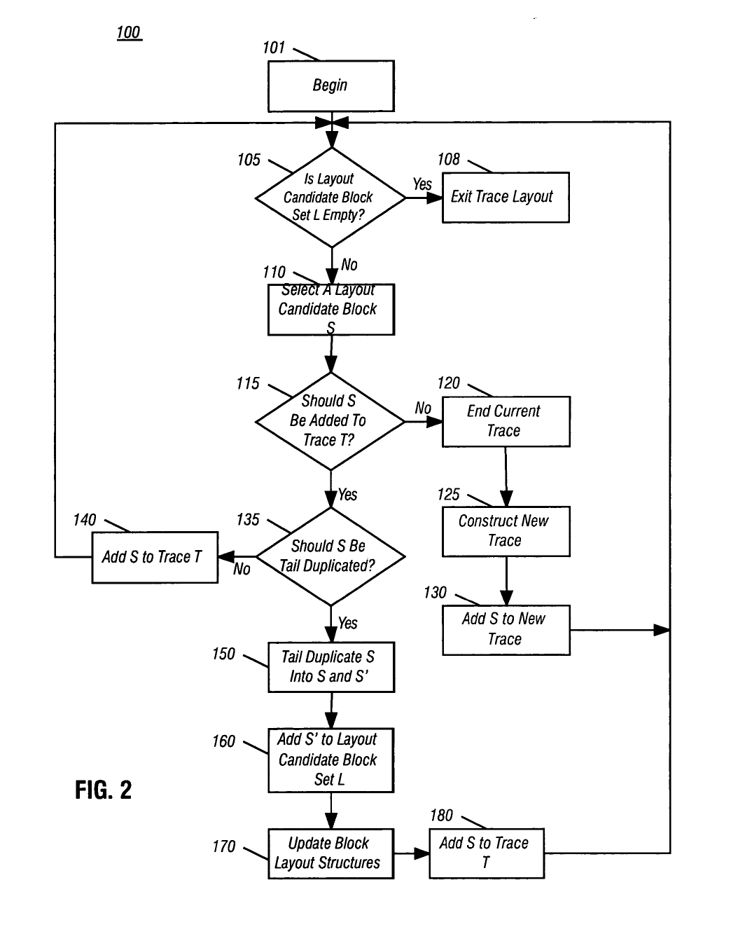

Referring now to FIG. 2, shown is a flow diagram of a method in accordance with another embodiment of the present invention. As shown in FIG. 2, method 100 may begin (block 101) by proceeding to determine whether a layout candidate block set L is empty (diamond 105). If the layout candidate block set is empty, trace layout may be exited (block 108).

Alternately if the layout candidate block set is not empty, next a layout candidate block S may be selected from a pool of available blocks (block 110). For example, such a selection may be performed by a block layout algorithm. In one embodiment, the layout candidate blocks may be initially populated with all basic blocks of the code segment undergoing compilation. Next the block layout algorithm may determine whether block S should be added to a trace currently being formed (e.g., a trace T)(diamond 115). In one embodiment, trace formation heuristics may be used to determine whether to add the block to the current trace. While such heuristics may vary in different embodiments, they may include analysis of measures such as trace length, complexity and the like. For example, if a probability of entry from a last block of a trace to a successor is not high enough, it may be desired to end the trace.

If it is determined that the block should not be added to the current trace, the current trace may be ended (block 120). Next a new empty trace may be constructed (block 125). Finally, the current candidate block S may be added to the new trace (block 130). Control may then return to diamond 105.

If instead it is determined that block candidate S should be added to the current trace T, next it may be determined whether block S should be tail duplicated (block 135). In one embodiment, trace formation heuristics may be used to determine whether tail duplication is desired. If no such duplication is desired, block S may be added to the current trace T (block 140). Control may then return to diamond 105.

If it is determined that block S should be tail duplicated, tail duplication may be performed (block 150) and block S may be duplicated into block S and tail duplicate block S′. Next, S′ may be added to the layout candidate block set L (block 160). Also, block layout structures of the block layout algorithm may be updated accordingly (block 170). For example, the layout algorithm upon notification of the tail duplication may mark the tail duplicate block as an unselected block and record the aggregate connection profile of S′ to already placed blocks. Finally, block S may be added to the current trace T (block 180). Control may then return to diamond 105.

In certain embodiments, a top-down block layout algorithm may be used for block layout. Alternately, other block layout algorithms, such as a bottom-up positioning algorithm or any other algorithm to implement tail duplication during block layout may be used. In a top-down block layout algorithm, the algorithm first places the entry block for the procedure, and thereafter picks the successor that is connected to the last placed basic block by the largest execution count. Such execution counts may be obtained via profiling, instrumentation, or other code analysis performed by a compiler prior to block layout.

If all successors have already been placed, the top-down algorithm then selects from the unselected basic blocks the block having the largest connection to the already placed blocks. Tail duplication may be desired on placing a block S if S has multiple predecessors, one of which is a block L that was placed just before S. When tail duplication is done, S is duplicated in S′ and all original predecessors of S other than L are transferred as predecessors of S′. The top-down layout algorithm may be notified of the duplication and may handle it by marking S′ as an unselected block, and recording the connection of S′ to already placed blocks.

An algorithm for integrated trace formation in accordance with one embodiment of the present invention is as follows:

```
L = Layout candidate block set [initially populated with
all basic blocks of the segment]
T = new Trace( )
while (L is not empty) {
    pick a layout candidate block S
    Determine if S should be added to trace T, and
      whether S should be tail duplicated
    if (block S should be added to trace T) {
        if (S should be tail duplicated) {
            Tail duplicate S into S and S′
            Add S′ to layout candidate block set L and
      update block layout structures
        }
        Add S to trace T
    }
    else {
        End current trace T
        T = new Trace( )
        Add S to trace T
    }
}
```

While embodiments may be implemented in various manners, certain embodiments may be implemented in a trace scheduling code generator for a JIT compiler for JAVA™ bytecodes and Microsoft Corporation's Common Language Interface (CLI) bytecodes. In such manner, various systems implementing virtual machines may more efficiently compile code with fewer tail duplications.

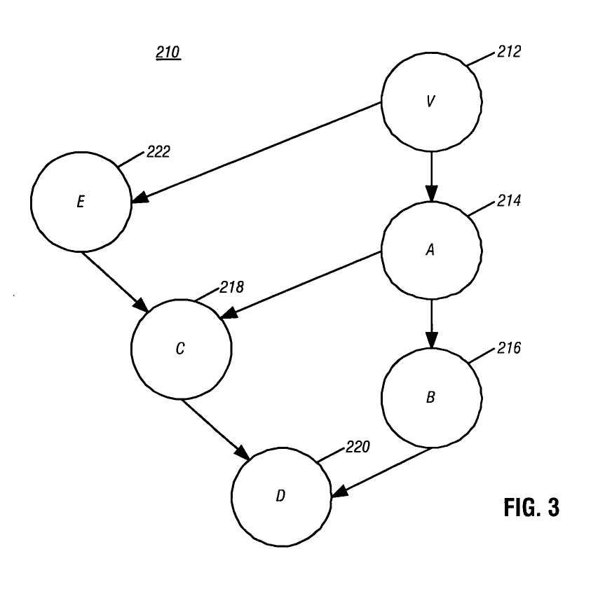

Referring now to FIG. 3, shown is a region 210 of code that includes a number of basic blocks. These basic blocks include block V 212, block A 214, block B 216, block C 218, block D 220, and block E 222. FIG. 3 illustrates a typical control flow diagram with edges between the various blocks of region 210.

In accordance with an embodiment of the present invention using a top-down algorithm, an integrated phase including tail duplication, block layout, and trace formation may be performed on the basic blocks of region 210. In such manner, the number of tail duplicates may be reduced. For example, during block layout, blocks may be tail duplicated only following a block that has been laid out and prior to laying out of the block that is to be tail duplicated.

Further, in certain embodiments, tail duplication may be based on an analysis of a probability of side entry and/or how many tail duplicates have already been formed in a given trace. For example, in one embodiment only a single tail duplication may be present in a given trace. Similarly, only a single side entry may be allowed in a given trace. Thus, in certain embodiments, tail duplication may be allowed only for a successor to a block that has immediately been laid out and prior to laying out the successor block.

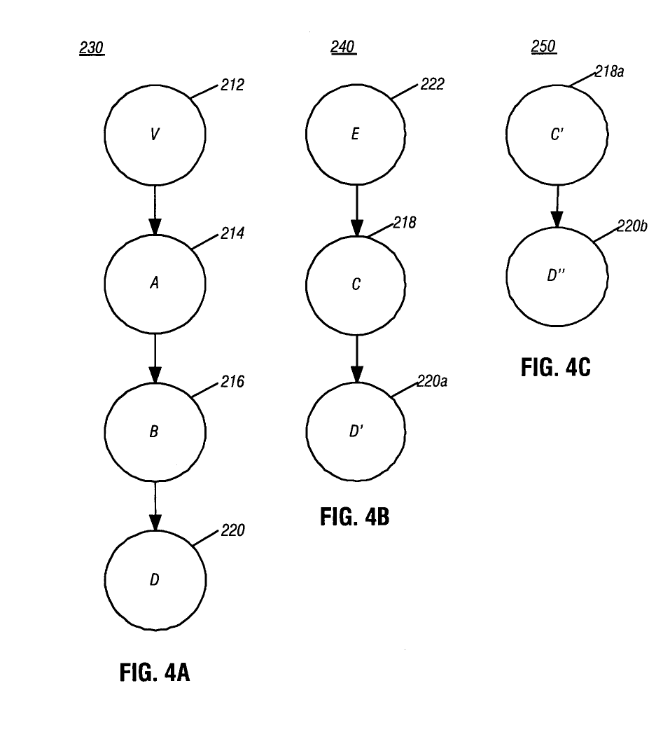

Referring now to FIG. 4A, shown is a first trace formed in accordance with an embodiment of the present invention from the basic blocks shown in FIG. 3. As shown in FIG. 4A, trace 230 includes block V 212 succeeded by block A 214, which in turn is succeeded by block B 216, which in turn is succeeded by block D 220. In an embodiment incorporating a top-down algorithm, the control flow from block V 212 to block A 214 may be selected for the trace based on profiling information which indicates that as between the edge from block V 212 to block A 214 and the edge between block V 212 and block E 222, the edge between blocks V 212 and A 214 is the more probable occurrence. A similar analysis may lead to the layout of blocks B 216 and D 220 following block A 214.

Because block D 220 may be entered from either of block B 216 and block C 218, tail duplication may be performed. In accordance with an embodiment of the present invention, such tail duplication may be performed immediately after laying out of block B 216 and prior to laying out of block D 220. Such tail duplication may thereby form a tail duplicate block D′ 220A (not shown in FIG. 4A).

Referring now to FIG. 4B, shown is a second trace 240 formed from the basic blocks of region 210. As shown in FIG. 4B, trace 240 may be laid out using a top-down algorithm in which tail duplication is performed while laying out the blocks. Using profile information associated with the blocks of region 210, trace 240 may be laid out such that block E 222 is succeeded by block C 218, which in turn is succeeded by tail duplicate block D′ 220a.

Because block C may be entered from two separate paths, another tail duplication process may be performed immediately after laying out of block E 222 and prior to laying out of block C 218, forming a tail duplicate block C′ 218a (not shown in FIG. 4B). Similarly, because block D′ 220a may be entered from multiple points, it too may be tail duplicated as tail duplicate block D″ 220b (not shown in FIG. 4B).

Thus as shown in FIG. 4C, a third trace 250 may be formed from the basic blocks of region 210. As shown in FIG. 4C, trace 250 may similarly be laid out using the top-down algorithm. Third trace 250 may include block C′ 218a succeeded by block D″ 220b.

Embodiments may be implemented in code and may be stored on a storage medium having stored thereon instructions which can be used to program a computer system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), flash memories, electrically erasable programmable read-only memories (EEPROMs), magnetic or optical cards, or any type of media suitable for storing electronic instructions.

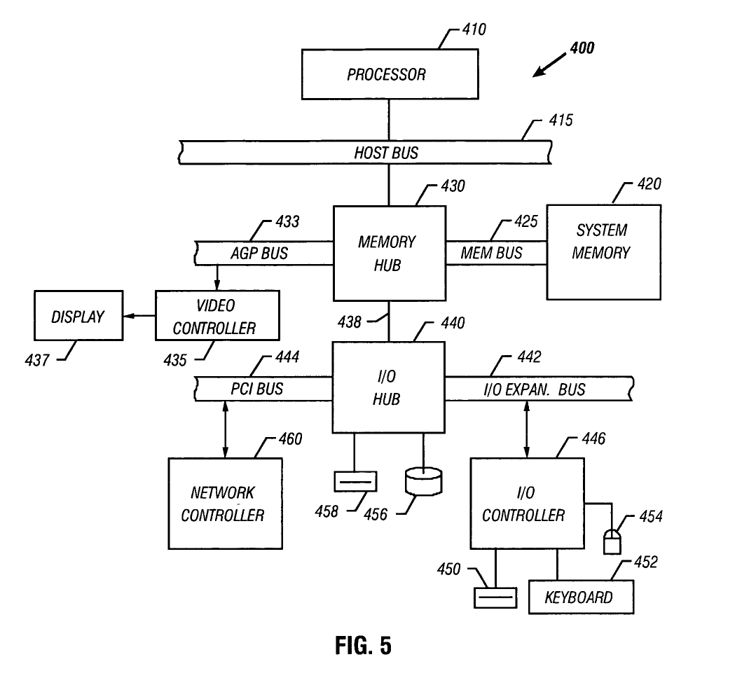

Example embodiments may be implemented in software for execution by a suitable computer system configured with a suitable combination of hardware devices. FIG. 5 is a block diagram of computer system 400 with which embodiments of the invention may be used.

Now referring to FIG. 5, in one embodiment, computer system 400 includes a processor 410, which may include a general-purpose or special-purpose processor such as a microprocessor, microcontroller, a programmable gate array (PGA), and the like. As used herein, the term “computer system” may refer to any type of processor-based system, such as a desktop computer, a server computer, a laptop computer, an appliance or set-top box, or the like.

The processor 410 may be coupled over a host bus 415 to a memory hub 430 in one embodiment, which may be coupled to a system memory 420 via a memory bus 425. The memory hub 430 may also be coupled over an Advanced Graphics Port (AGP) bus 433 to a video controller 435, which may be coupled to a display 437. The-AGP bus 433 may conform to the Accelerated Graphics Port Interface Specification, Revision 2.0, published May 4, 1998, by Intel Corporation, Santa Clara, Calif.

The memory hub 430 may also be coupled (via a hub link 438) to an input/output (I/O) hub 440 that is coupled to a input/output (I/O) expansion bus 442 and a Peripheral Component Interconnect (PCI) bus 444, as defined by the PCI Local Bus Specification, Production Version, Revision 2.1 dated June 1995. The I/O expansion bus 442 may be coupled to an I/O controller 446 that controls access to one or more I/O devices. As shown in FIG. 5, these devices may include in one embodiment storage devices, such as a floppy disk drive 450 and input devices, such as keyboard 452 and mouse 454. The I/O hub 440 may also be coupled to, for example, a hard disk drive 456 and a compact disc (CD) drive 458, as shown in FIG. 5. It is to be understood that other storage media may also be included in the system.

The PCI bus 444 may also be coupled to various components including, for example, a network controller 460 that is coupled to a network port (not shown). Additional devices may be coupled to the I/O expansion bus 442 and the PCI bus 444, such as an input/output control circuit coupled to a parallel port, serial port, a non-volatile memory, and the like.

Although the description makes reference to specific components of the system 400, it is contemplated that numerous modifications and variations of the described and illustrated embodiments may be possible. More so, while FIG. 5 shows a block diagram of a system such as a personal computer, it is to be understood that embodiments of the present invention may be implemented in a wireless device such as a cellular phone, personal digital assistant (PDA) or the like. In such embodiments, a flash memory may be coupled to an internal bus which is in turn coupled to a microprocessor and a peripheral bus, which may in turn be coupled to a wireless interface and an associated antenna such as a dipole antenna, helical antenna, global system for mobile communication (GSM) antenna, and the like.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
duplicating a block of a code segment into a tail duplicate block during block layout of the code segment.

2. The method of claim 1, further comprising updating a data structure corresponding to the block layout.

3. The method of claim 2, wherein updating the data structure comprises marking the tail duplicate block as an unselected block.

4. The method of claim 2, wherein updating the data structure comprises recording a connection between the tail duplicate block and a placed block.

5. The method of claim 1, wherein the block layout comprises a top-down block layout.

6. The method of claim 1, further comprising performing the duplicating in a just-in-time compiler.

7. The method of claim 1, further comprising performing the duplicating in a managed-runtime environment.

8. The method of claim 1, further comprising performing the duplicating while performing trace formation.

9. The method of claim 8, further comprising using feedback from the trace formation to determine whether to perform the duplicating.

10. The method of claim 8, wherein the trace formation comprises hyperblock formation.

11. A method comprising:
selecting a block from a candidate block set for layout;
duplicating the block into a tail duplicate block; and
adding the block to a trace after duplicating the block.

12. The method of claim 11, further comprising determining whether to duplicate the block based on trace formation heuristics.

13. The method of claim 11, further comprising using feedback from forming the trace to determine whether to perform tail duplication on the block.

14. The method of claim 11, further comprising adding the tail duplicate block to the candidate block set.

15. The method of claim 11, further comprising updating at least one block layout structure with information regarding the tail duplicate block.

16. The method of claim 11, further comprising duplicating the block while forming the trace.

17. The method of claim 11, further comprising using profile information to select the block.

18. The method of claim 11, further comprising duplicating the block if the block has more than one predecessor block.

19. The method of claim 11, wherein the trace comprises a hyperblock.

20. An article comprising a machine-readable storage medium containing instructions that if executed enable a system to:
duplicate a block of a code segment into a tail duplicate block during block layout of the code segment.

21. The article of claim 20, further comprising instructions that if executed enable the system to update a data structure corresponding to the block layout.

22. The article of claim 20, further comprising instructions that if executed enable the system to mark the tail duplicate block as an unselected block.

23. The article of claim 20, further comprising instructions that if executed enable the system to record a connection between the tail duplicate block and a placed block.

24. The article of claim 20, further comprising instructions that if executed enable the system to duplicate the block via a just-in-time compiler.

25. The article of claim 20, further comprising instructions that if executed enable the system to duplicate the block while performing trace formation.

26. The article of claim 25, further comprising instructions that if executed enable the system to use feedback from the trace formation to determine whether to duplicate the block.

27. A system comprising:
a processor; and
a dynamic random access memory coupled to the processor including instructions that if executed enable the system to duplicate a block of a code segment into a tail duplicate block during block layout of the code segment.

28. The system of claim 27, wherein the dynamic random access memory further includes instructions that if executed enable the system to update a data structure corresponding to the block layout.

29. The system of claim 27, wherein the dynamic random access memory further includes instructions that if executed enable the system to mark the tail duplicate block as an unselected block.

30. The system of claim 27, wherein the dynamic random access memory further includes instructions that if executed enable the system to record a connection between the tail duplicate block and a placed block.
